(19) United States
(12) Patent Application Publication
(10) Pub. No.: US 2014/0017526 A1
(43) Pub. Date: Jan. 16, 2014

(54) NON-AQUEOUS ELECTROLYTE SECONDARY BATTERY SYSTEM

(71) Applicants: Masato Iwanaga, Tokushima (JP); Atsushi Kaiduka, Tokushima (JP); Shun Nomura, Tokushima (JP); Kota Ogawa, Osaka (JP); Naoya Tsukamoto, Osaka (JP)

(72) Inventors: Masato Iwanaga, Tokushima (JP); Atsushi Kaiduka, Tokushima (JP); Shun Nomura, Tokushima (JP); Kota Ogawa, Osaka (JP); Naoya Tsukamoto, Osaka (JP)

(73) Assignee: SANYO ELECTRIC CO., LTD., Moriguchi-shi, Osaka (JP)

(21) Appl. No.: 14/005,954

(22) PCT Filed: Mar. 21, 2012
(86) PCT No.: PCT/JP2012/057130

§ 371 Date: Sep. 18, 2013

(30) Foreign Application Priority Data
Mar. 31, 2011 (JP) 2011-080437

(51) Int. Cl. H01M 2/34; H01M 10/0569

(52) U.S. Cl. CPC H01M 2/34; H01M 10/0569
USPC 429/61

(57) ABSTRACT

A non-aqueous electrolyte secondary battery system includes a non-aqueous electrolyte secondary battery and a charging control system which has a function of detecting the voltage of the non-aqueous electrolyte secondary battery and disconnecting a charging circuit. The non-aqueous electrolytic solution contains a non-aqueous solvent having a viscosity of 0.6 cP or less at 25° C. in an amount of 35 to 80 vol % inclusive as a non-aqueous solvent and also contains hexamethylene diisocyanate, and the charging control system stops charging when the potential of the positive electrode of the non-aqueous electrolyte secondary battery is 4.35 to 4.6 V inclusive based on lithium. Thus the non-aqueous electrolyte secondary battery system equipped with the non-aqueous electrolyte secondary battery having high charging potential and excellent high-temperature cycling characteristics can be provided.

### TECHNICAL FIELD

The present invention relates to a nonaqueous electrolyte secondary battery system, and in particular to a nonaqueous electrolyte secondary battery system that has a high charge termination voltage, a high capacity, and excellent cycling characteristics under high-temperature environments.

### BACKGROUND ART

As a power supply for driving modern mobile electronic instruments such as a mobile phone, mobile personal computer, or mobile music player and further as a power supply for hybrid electric vehicles (HEVs), or electric vehicles (EVs), a nonaqueous electrolyte secondary battery represented by a lithium-ion secondary battery having high energy density and with high capacity is extensively utilized.

As a positive electrode active material of these nonaqueous electrolyte secondary batteries, a material capable of absorbing and desorbing lithium ions in a reversible manner, for example, a single one of or a mixture of a plurality of LiCoO₂, LiNiO₂, LiNiₓCo₁₋ₓO₂ (x=0.01 to 0.99), LiMnO₂, LiCoₓMn_{y}Ni_{z}O₂ (x+y+z=1), LiMn₂O₄, and LiFePO₄, is used.

Of these, lithium-cobalt composite oxides and lithium-cobalt composite oxide with dissimilar metal elements added thereto are commonly used because they are particularly superior to other materials in various battery characteristics. However, cobalt is expensive, and the existing amount as a resource is small. It is therefore required to further improve performance of nonaqueous electrolyte secondary batteries for continuing using such lithium-cobalt composite oxides and lithium-cobalt composite oxide with dissimilar metal elements added thereto as a positive electrode active material of the nonaqueous electrolyte secondary batteries.

Raising a charge termination voltage can be considered as one way of increasing the capacity of the nonaqueous electrolyte secondary battery that includes such a lithium-cobalt composite oxide as the positive electrode active material. However, raising the charge termination voltage of the nonaqueous electrolyte secondary battery poses a problem of deteriorating the cycling characteristics and storage characteristics. This deterioration in the cycling characteristics and the storage characteristics associated with the raising of the charge termination voltage is known to be significant under high-temperature environments in particular. Although the detailed mechanism is not yet known, an increase in the decomposed matter in the electrolyte and elution of positive electrode active material elements into the electrolyte are observed in results of analysis of nonaqueous electrolyte secondary batteries in which the deterioration in the cycling characteristics and the storage characteristics have occurred, and thus are presumed to cause the deterioration in the cycling characteristics and the storage characteristics.

In general, as indicated in Patent Documents 1 and 2 listed below, for example, a nonaqueous electrolyte secondary battery includes a nonaqueous electrolyte containing a low-viscosity solvent such as dimethyl carbonate (DMC) and methyl propionate (MP) mixed therein. Mixing such a low-viscosity solvent into the nonaqueous electrolyte improves the cycling characteristics under room temperature (25° C.), but, in contrast, causes the cycling characteristics to deteriorate under high-temperature environments. This phenomenon is observed more significantly when a charging voltage is raised. This is considered to be because the low-viscosity solvent is likely to oxidatively decompose on the positive electrode whose potential has been raised. However, the low-viscosity solvent is a component necessary for ensuring sufficient ion conductivity in the electrolyte, and thus is required to be kept at a certain amount in the electrolyte. This leads to a consideration of how to prevent the oxidative decomposition of the low-viscosity solvent on the positive electrode to increase the capacity of the nonaqueous electrolyte secondary battery by raising the voltage.

In the nonaqueous electrolyte secondary battery, repetition of charge and discharge promotes reductive decomposition of the solvent contained in the nonaqueous electrolyte, and thus poses problems such as deformation, burst, and capacity drop of the battery associated with the decomposition and vaporization of the solvent. In particular, a nonaqueous electrolyte secondary battery including graphite as a negative electrode active material exhibits a very strong reducing power, and thus has a tendency in which the solvent significantly decomposes. This has led to a proposal of a method in which a compound forming a coating called a solid electrolyte interface (SEI) on the negative electrode is added to the electrolyte in advance to prevent the reductive decomposition of the solvent on the negative electrode. For example, Patent Documents 3 and 4 listed below disclose that addition of a diisocyanate compound such as hexamethylene diisocyanate (HMDI) into the nonaqueous electrolyte improves the cycling characteristics. These proposals are both based on the effect of forming the SEI protective coating on the negative electrode plate.
Patent Document 1: JP-A-9-97609
Patent Document 2: JP-A-2005-259708
Patent Document 3: JP-A-2006-164759
Patent Document 4: JP-A-2007-242411

### DISCLOSURE OF INVENTION

### Problem to be Solved by the Invention

According to the invention of the nonaqueous electrolyte secondary battery disclosed in each of Patent Documents 3 and 4 listed above, a stable SEI is formed on the negative electrode due to charging at an initial stage of use. This prevents the decomposition of the solvent, and thus brings about the effect of improvement in the cycling characteristics and the high-temperature storage characteristics, and an effect of suppression of swelling of the battery. However, while Patent Documents 3 and 4 listed above each disclose the nonaqueous electrolyte secondary battery including the electrolyte to which a diisocyanate compound is added, they only illustrate an example in which a charge-discharge cycle was conducted by performing a constant current charge until the battery voltage reached 4.2 V and performing a charge at a constant voltage of 4.2 V after the battery voltage reached 4.2 V. This means that Patent Documents 3 and 4 listed above suggest nothing about what effect is given by the diisocyanate compound to the low-viscosity solvent under a high charging voltage with the battery voltage exceeding 4.2 V. The positive electrode has a potential of 4.3 V based on lithium when charged, because the nonaqueous electrolyte secondary battery of these conventional examples includes a negative electrode plate containing a carbonaceous material as the negative electrode active material, and the carbonaceous material has a potential of 0.1 V based on lithium.

The inventors of the present invention conducted various studies about additives that can prevent the deterioration in the cycling characteristics under high-temperature environments when charging is conducted until the positive electrode potential reaches 4.35 V or more based on lithium while using a nonaqueous electrolyte with a low-viscosity solvent such as DMC and MP mixed therein. As a result, the inventors of the present invention have completed the present invention through finding that further addition of HMDI as a diisocyanate compound into the nonaqueous electrolyte can solve the problem that the low-viscosity solvent are likely to oxidatively decompose on the positive electrode whose potential has been raised.

Specifically, the present invention provides a nonaqueous electrolyte secondary battery system that includes a nonaqueous electrolyte with a low-viscosity solvent such as DMC and MP mixed therein and has excellent cycling characteristics under high-temperature environments when charging is conducted until the positive electrode potential reaches 4.35 V or more based on lithium.

### Means for Solving Problem

To achieve the above-described objective, a nonaqueous electrolyte secondary battery system of the present invention includes: a nonaqueous electrolyte secondary battery including a positive electrode plate containing a positive electrode active material that is capable of absorbing and desorbing lithium in a reversible manner, a negative electrode plate containing a negative electrode active material that is capable of absorbing and desorbing lithium in a reversible manner, a separator, and a nonaqueous electrolyte in which an electrolyte salt is dissolved in a nonaqueous solvent; and a charging control system detecting a voltage of the nonaqueous electrolyte secondary battery and disconnecting a charging circuit. In the nonaqueous electrolyte secondary battery system of the present invention, the nonaqueous electrolyte contains a nonaqueous solvent having a viscosity of 0.6 cP or less at 25° C. in an amount of 35 to 80% by volume inclusive as the nonaqueous solvent and also contains HMDI, and the charging control system stops charging when the potential of the positive electrode of the nonaqueous electrolyte secondary battery is 4.35 to 4.6 V inclusive based on lithium.

In the nonaqueous electrolyte secondary battery of the nonaqueous electrolyte secondary battery system of the present invention, the nonaqueous electrolyte contains a nonaqueous solvent having a viscosity of 0.6 cP or less at 25° C. in an amount of 35 to 80% by volume inclusive as the nonaqueous solvent, and thus is a nonaqueous electrolyte having sufficient ion conductivity, thereby improving the cycling characteristics under room temperature (25° C.). The nonaqueous electrolyte also contains HMDI. Thus, when the charging control system controls the charging so that the potential of the positive electrode of the nonaqueous electrolyte secondary battery is 4.35 to 4.6 V inclusive, the decomposition of the low-viscosity solvent is prevented on a surface of the positive electrode, thereby preventing the deterioration in the cycling characteristics of the nonaqueous electrolyte secondary battery under high-temperature environments.

As the nonaqueous solvent having a viscosity of 0.6 cP or less at 25° C. in the present invention, various solvents can be used, such as dimethyl carbonate (DMC, 0.6 cP), methyl acetate (0.37 cP), methyl ethyl ketone (0.42 cP), ethyl acetate (0.43 cP), methyl propionate (0.43 cP), and n-propyl acetate (0.59 cP).

If the nonaqueous solvent having a viscosity of 0.6 cP or less at 25° C. is contained in the nonaqueous electrolyte at a rate of content of less than 35% by volume, the cycling characteristics deteriorates under high-temperature environments. If the nonaqueous solvent is included at a rate of content of more than 80% by volume, the rate of content of a high-viscosity component having a relatively high permittivity is reduced. This reduces the amount of the electrolyte salt soluble in the nonaqueous solvent, leading to a reduction in the ion conductivity of the nonaqueous electrolyte. This increases the internal resistance of the nonaqueous electrolyte secondary battery.

When the positive electrode potential at which the charging control system stops the charging of the nonaqueous electrolyte secondary battery is controlled to less than 4.35 V based on lithium, the battery capacity drops although the cycling characteristics under high-temperature environments are good. When the positive electrode potential at which the charging control system stops the charging of the nonaqueous electrolyte secondary battery is controlled to more than 4.60 V based on lithium, decomposition of the positive electrode active material and the oxidative decomposition of the nonaqueous electrolyte are likely to occur, and thus such a value is undesirable.

Examples of a nonaqueous solvent that can be used while being mixed with the nonaqueous solvent having a viscosity of 0.6 cP or less at 25° C. of the present invention include: a cyclic carbonate such as ethylene carbonate (EC), propylene carbonate (PC), and butylene carbonate (BC); a fluorinated cyclic carbonate; a cyclic carboxylic ester such as γ-butyrolactone (γ-BL) and γ-valerolactone (γ-VL); a chain carbonate such as ethyl methyl carbonate (EMC), diethyl carbonate (DEC), methylpropyl carbonate (MPC), and dibutyl carbonate (DBC); a fluorinated chain carbonate; a chain carboxylic ester such as methyl pivalate, ethyl pivalate, methyl isobutyrate, and methyl propionate; an amide compound such as N,N′-dimethylformamide and N-methyl oxazolidinone; and a sulfur compound such as sulfolane. It is desirable that two or more of them be mixed to be used. Of these, preferred are a cyclic carbonate ester and a chain carbonate ester that have a particularly large permittivity and large nonaqueous electrolyte ion conductivity.

Within the nonaqueous electrolyte used in the present invention, the following compounds may be further added as compounds for stabilization of an electrode: vinylene carbonate (VC), vinyl ethyl carbonate (VEC), propane sultone (PS), propene sultone, succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl. Two or more of these compounds can also be mixed for use as appropriate.

In the nonaqueous electrolyte of the present invention, a lithium salt that is commonly used as an electrolyte salt for an nonaqueous electrolyte secondary battery may be used as an electrolyte salt dissolved in the nonaqueous solvent. Examples of such a lithium salt are as follows: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. In particular, among them, it is preferable that LiPF₆ (lithium hexafluorophosphate) be used. The amount of dissolution of the electrolyte salt with respect to the nonaqueous solvent is preferably 0.5 to 2.0 mol/L inclusive.

As the positive electrode active material usable in the nonaqueous electrolyte secondary battery in the present invention, any material that is commonly used can be used as long as it can stably exist under the potential of the positive electrode of 4.35 to 4.6 V inclusive based on lithium and can absorb and desorb lithium ions in a reversible manner. In particular, a dissimilar metal-added lithium-cobalt composite oxide that contains at least one selected from Zr, Mg, Al, and lanthanoid elements as dissimilar metals is preferred. Erbium (Er) is preferable as a lanthanoid element.

The negative electrode active material that can be used in the nonaqueous electrolyte secondary battery of the present invention is not limited in any way as long as it is a material capable of absorbing and desorbing lithium in a reversible manner. For example, the following materials may be used: a carbon material such as graphite, nongraphitizable carbon, and graphitizable carbon; a titanium oxide such as LiTiO₂ and TiO₂; a metalloid element such as silicon and tin; and a Sn—Co alloy.

As the separator that can be used in the nonaqueous electrolyte secondary battery in the present invention, a polyolefin microporous membrane can be used that is commonly used as a separator. The separator preferably contains polyethylene that excels in permeability and shutdown properties. The separator preferably includes a polyolefin microporous membrane containing inorganic particles as a surface layer thereof. The material of the inorganic particles to be contained in the surface layer of the separator is preferably at least one of oxides and nitrides of silicon, aluminum, and titanium, and more preferably silicon dioxide and aluminum oxide.

In the nonaqueous electrolyte secondary battery system of the present invention, the nonaqueous electrolyte preferably contains HMDI in an amount of 0.5 to 4.0% by mass inclusive.

If HMDI is contained in an amount of 0.5 to 4.0% by mass inclusive of the nonaqueous electrolyte, an effect of improvement in the high-temperature cycling characteristics is significantly exhibited.

In the nonaqueous electrolyte secondary battery system of the present invention, the negative electrode active material is preferably a carbonaceous material. When the carbon material is used as the negative electrode active material, the charging control system in the present invention stops the charging of the nonaqueous electrolyte secondary battery at a voltage in the range from 4.25 to 4.5 V inclusive between terminals of the positive and negative electrodes, because the carbon material has a potential of 0.1 V based on lithium.

### BEST MODES FOR CARRYING OUT THE INVENTION

An embodiment for carrying out the present invention will be described below in detail using examples and comparative examples. The examples below show examples of a nonaqueous electrolyte secondary battery for embodying the technical idea of the present invention and is not intended to specify the present invention as the examples. The present invention is equally applicable to various modifications without departing from the technical idea shown in the scope of claims.

First, a specific manufacturing method of a nonaqueous electrolyte secondary battery of each example and comparative example will be described.

[Positive Electrode Active Material]

Lithium cobalt oxide with erbium hydroxide attached to the surface thereof was used as the positive electrode active material. This active material was prepared as follows. As starting materials, lithium carbonate (Li₂CO₃) was used as a lithium source, and tricobalt tetroxide (Co₃O₄) was used as a cobalt source. These materials were weighed and mixed so as to give a molar ratio of 1:1 between lithium and cobalt, and then baked at 850° C. for 24 hours in an air atmosphere to obtain the lithium cobalt oxide. The lithium cobalt oxide thus obtained was pulverized in a mortar to an average particle diameter of 15 nm, and then 1000 g thereof was added to 3 liters of pure water and stirred to prepare a suspension in which the lithium cobalt oxide was dispersed.

To this suspension, an aqueous solution in which 4.53 g of erbium trinitrate pentahydrate (Er(NO₃)₃.5H₂O) was dissolved was added so that a rate of content thereof was 0.1 mol % relative to the lithium cobalt oxide in terms of erbium element. When the solution was added to the suspension, an aqueous sodium hydroxide solution of 10% by mass was also added to keep pH of the suspension at 9. Subsequently, the suspension was filtered by suction and washed with water, and the powder thus obtained was dried at 120° C. As a result, the lithium cobalt oxide was obtained with the erbium hydroxide uniformly attached to the surface thereof. Subsequently, the lithium cobalt oxide with the erbium hydroxide attached thereto was treated with heat at 300° C. for five hours in the air to obtain the positive electrode active material to be commonly used in the nonaqueous electrolyte secondary batteries of the examples and the comparative examples.

[Preparation of Positive Electrode Plate]

A slurry was prepared by mixing 94 parts by mass of the positive electrode active material obtained as above, 3 parts by mass of a carbon powder as a conducting agent, and 3 parts by mass of polyvinylidene fluoride (PVdF) powder as a binding agent, and mixing the resultant substance with an N-methylpyrrolidone (NMP) solution. This slurry was applied by a doctor blade method to both surfaces of a positive electrode corrector formed of aluminum with a thickness of 15 nm and then was dried, thereby forming a positive electrode active material layer on both surfaces of the positive electrode collector. Next, through compression using a compression roller, a positive electrode plate commonly used in the examples and comparative examples was prepared.

[Preparation of Negative Electrode Plate]

A slurry was prepared by dispersing 96 parts by mass of graphite as a negative electrode active material, 2 parts by mass of carboxymethyl cellulose as a thickening agent, 2 parts by mass of styrene-butadiene rubber (SBR) as a binding agent into water. This slurry was applied by a doctor blade method to both surfaces of a negative electrode corrector formed of copper with a thickness of 8 μm and then was dried, thereby forming a negative electrode active material layer on both surfaces of the negative electrode collector. Next, through compression using a compression roller, a negative electrode plate commonly used in the examples and comparative examples was prepared.

The potential of graphite is about 0.1 V based on Lithium as the reference. The filling amount of the active materials of the positive electrode plate and the negative electrode plate was adjusted such that the charge capacity ratio (negative electrode charge capacity/positive electrode charge capacity) of the positive electrode plate and the negative electrode plate is 1.1 at the potential of the positive electrode active material that is the design reference.

[Preparation of Nonaqueous Electrolyte]

Monofluoroethylene carbonate (FEC), ethylene carbonate (EC), propylene carbonate (PC), methylethyl carbonate (MEC), dimethyl carbonate (DEC), and the methyl propionate (MP) were mixed so as to form compositions in volume ratios shown in Table 1 below to obtain nonaqueous solvents. To these mixed solvents, 1.2 mol/L of LiPF₆ was dissolved to prepare electrolyte samples. Vinylene carbonate (VC) and adiponitrile were added to each of the electrolyte samples so as to form 2% by mass and 1% by mass relative to each of the electrolytes. Furthermore, hexamethylene diisocyanate (HMDI) was not added (Comparative Examples 1 and 3 to 6), or was added to form 0.5% by mass (Example 1 and Comparative Example 7), 1% by mass (Comparative Example 2 and Examples 2 to 4), and 4% by mass (Example 5). Thus, the nonaqueous electrolytes were prepared to be used in the nonaqueous electrolyte secondary batteries of Examples 1 to 5 and Comparative Examples 1 to 7. In these mixed solvents, the dimethyl carbonate (DMC, 0.6 cP) and the methyl propionate (MP, 0.43 cP) correspond to the low-viscosity nonaqueous solvent having a viscosity of 0.6 cP or less at 25° C. in the present invention.

[Preparation of Separator]

A microporous membrane of polyethylene having three layers was used as the separator to be used in each of the examples and comparative examples. The raw material of two layers corresponding to surfaces was prepared by mixing polyethylene and silicon dioxide (SiO₂) as inorganic particles at a mass ratio of 86:14 and stirring the mixture with a mixer. The raw material of an intermediate layer interposed between the two surface layers was polyethylene. The raw materials of the surface layers and the intermediate layer were each kneaded with liquid paraffin as a plasticizing agent. Thereafter, the layers were formed, while each being kneaded and heated to melt, into a sheet-like form having three layers using a co-extrusion method so as to be the separator in which the layers containing the inorganic particles were arranged as the surface layers on both sides. Subsequently, the separator was stretched, and dried and stretched after the plasticizer was extracted to be removed, thereby preparing the microporous membrane of polyethylene having three layers including the two surface layers each having a thickness of 2 μm and the intermediate layer having a thickness of 10 μm.

[Preparation of Nonaqueous Electrolyte Secondary Battery]

The separator prepared as described above was interposed between the positive electrode plate and the negative electrode plate each prepared as described above, and the whole was wound, thereby preparing a wound electrode assembly. The wound electrode assembly was housed into a cylindrical metal outer can, and then the electrolyte corresponding to each of the examples and comparative examples was poured into the cylindrical metal outer can to prepare a cylindrical nonaqueous electrolyte secondary battery according to each of the examples and comparative examples. The obtained nonaqueous electrolyte secondary battery had a cylindrical shape having a diameter of 18 mm and a height of 65 mm, and had a design capacity of 2900 mAh with a charging voltage of 4.35 V.

[Evaluation of Room-Temperature Cycling Characteristics]

Each of the batteries of Examples 1 to 5 and Comparative Examples 1 to 5 prepared as described above was charged under an environment of 45° C. at a constant current of 0.5 It=1450 mA until the battery voltage reached 4.35 V (4.45 V based on lithium in terms of the potential of the positive electrode). After the battery voltage reached 4.35 V, the battery was charged at a constant voltage of 4.35 V until the charging current reached 1/50 It=58 mA. Thus, a fully charged battery was obtained. Subsequently, the battery was discharged at a constant current of 1 It=2900 mA until the battery voltage reached 3.0 V. The above-described charge and discharge were assumed as one cycle, and a discharge capacity after the first cycle was measured. The charging voltage for each of the batteries of Examples 1 to 5 and Comparative Examples 1 to 5 was controlled using a known charging control system capable of switching the constant current charge and the constant voltage charge.

The above-described charge and discharge were repeated, and the discharge capacity was measured after the 250th cycle. A capacity retention ratio was obtained from the following equation. The room-temperature cycling characteristics were evaluated as follows: “A” indicates that the battery had a capacity retention ratio of 80% or more; “B” indicates that the battery had a capacity retention ratio of 70% or more and less than 80%; and “C” indicates that the battery had a capacity retention ratio of less than 70%. The measurement was performed on each of the batteries of Comparative Examples 6 and 7 in the same way as the examples and the other comparative examples except that the batteries of Comparative Examples 6 and 7 were each charged until the battery voltage reached 4.2 V (4.3 V based on lithium in terms of the potential of the positive electrode) during the charge. Results are collectively shown in Table 1.

Capacity retention ratio (%)=(discharge capacity at 250th cycle/discharge capacity at first cycle)×100

TABLE 1

| | Charging | Mixed solvent (% by volume) | | | | | | HMDI | Capacity retention ratio | |
|---|---|---|---|---|---|---|---|---|---|---|
| | voltage | FEC | EC | PC | MEC | DMC | MP | (% by mass) | (%) | Determination |
| Comparative | 4.35 V | 15 | 10 | 5 | 70 | 0 | 0 | 0 | 71 | B |
| Example 1 | | | | | | | | | | |
| Comparative | 4.35 V | 15 | 10 | 5 | 70 | 0 | 0 | 1 | 76 | B |
| Example 2 | | | | | | | | | | |
| Comparative | 4.35 V | 15 | 10 | 5 | 35 | 35 | 0 | 0 | * | C |
| Example 3 | | | | | | | | | | |
| Comparative | 4.35 V | 15 | 10 | 5 | 0 | 70 | 0 | 0 | * | C |
| Example 4 | | | | | | | | | | |
| Comparative | 4.35 V | 15 | 10 | 5 | 35 | 0 | 35 | 0 | * | C |
| Example 5 | | | | | | | | | | |
| Example 1 | 4.35 V | 15 | 10 | 5 | 35 | 35 | 0 | 0.5 | 82 | A |
| Example 2 | 4.35 V | 15 | 10 | 5 | 35 | 35 | 0 | 1 | 86 | A |
| Example 3 | 4.35 V | 15 | 10 | 5 | 0 | 70 | 0 | 1 | 83 | A |
| Example 4 | 4.35 V | 15 | 10 | 5 | 35 | 0 | 35 | 1 | 86 | A |
| Example 5 | 4.35 V | 15 | 10 | 5 | 35 | 35 | 0 | 4 | 81 | A |
| Comparative | 4.2 V | 15 | 10 | 5 | 35 | 35 | 0 | 0 | 88 | A |
| Example 6 | | | | | | | | | | |
| Comparative | 4.2 V | 15 | 10 | 5 | 35 | 35 | 0 | 0.5 | 89 | A |
| Example 7 | | | | | | | | | | |

* Impossible to perform 250 cycles of charge and discharge

The results in Table 1 show the following. That is, according to the results of Comparative Examples 1 and 2, when the low-viscosity solvent having a viscosity of 0.6 cP or less at 25° C. was not added into the nonaqueous electrolyte, the capacity retention ratio did not reach 80% but was ensured to be 70% or more in both cases where HMDI was not added (Comparative Example 1) and was added (Comparative Example 2). Furthermore, the capacity retention ratio was higher in the case in which HMDI was added (Comparative Example 2) than in the case in which HMDI was not added (Comparative Example 1). This shows that HMDI has the effect of improvement in the high-temperature cycling characteristics when the low-viscosity solvent having a viscosity of 0.6 cP or less at 25° C. is not added into the nonaqueous electrolyte.

According to the results of Comparative Examples 3 to 5, when HMDI was not added, the batteries failed to withstand 250 cycles of charge and discharge at a high temperature whichever the low-viscosity solvent having a viscosity of 0.6 cP or less at 25° C. was added into the nonaqueous electrolyte in an amount of 35% by volume (Comparative Examples 3 and 5) or 70% by volume (Comparative Example 4), and it became impossible halfway to perform the charge-discharge cycle. This is presumed to be caused by oxidative decomposition of the low-viscosity solvent having a viscosity of 0.6 cP or less on the positive electrode surface due to the high battery voltage of 4.35 V during the charge, in consideration that the VC known as an agent for forming an SEI protective coating on the negative electrode surface was added into the nonaqueous electrolyte.

According to the results of Examples 1, 2, 4 and 5, when the low-viscosity solvent having a viscosity of 0.6 cP or less at 25° C. was added into the nonaqueous electrolyte in an amount of 35% by volume, the capacity retention ratio was ensured to be 80% or more in all cases in which the HMDI addition amount was 0.5% by mass (Example 1), 1% by mass (Examples 2 and 4) and 4% by mass (Example 5). The batteries with the HMDI addition amount of 1% by mass (Examples 2 and 4) achieved the best capacity retention ratio. This indicates that there is a local maximum of the HMDI addition amount in the nonaqueous electrolyte, and shows that the HMDI addition amount is preferably 0.5 to 4% by mass inclusive.

According to the results of Examples 2 to 4 in which the HMDI addition amount was 1% by mass, the capacity retention ratio was lower in the case in which the addition ratio of the low-viscosity solvent having a viscosity of 0.6 cP or less at 25° C. in the nonaqueous electrolyte was 70% by volume (Example 3) than in the case in which the addition ratio was 35% by volume (Examples 2 and 4). However, the capacity retention ratio was ensured to be 80% or more when the addition ratio was 80% by volume or less. Therefore, the addition ratio of the low-viscosity solvent having a viscosity of 0.6 cP or less at 25° C. in the nonaqueous electrolyte is preferably 35 to 80% by volume inclusive, and more preferably 35 to 70% by volume inclusive.

The same capacity retention ratio is obtained in Examples 2 and 4 in which the rates of content of the low-viscosity solvent having a viscosity of 0.6 cP or less at 25° C. were the same value of 35% by volume, although the different kinds of solvents, that is, DMC and MP were used in Example 2 and Example 4, respectively. This means that the same functional effect is obtained regardless of the kinds of the low-viscosity solvent having a viscosity of 0.6 cP or less at 25° C. added into the nonaqueous electrolyte.

In Comparative Examples 6 and 7, the charging voltage is as low as 4.2 V (4.3 V based on lithium in terms of the positive electrode potential). This leads to a very good capacity retention ratio of 88% or more in both cases in which the HMDI was not added (Comparative Example 6) and added in an amount of 0.1% by mass (Comparative Example 7), in both of which the addition ratio of the low-viscosity solvent having a viscosity of 0.6 cP or less at 25° C. in the nonaqueous electrolyte was 35% by volume. However, in Comparative Examples 6 and 7, a relatively low discharge capacity of about 2700 mAh was obtained because of the low charging voltage. In all of Examples 1 to 5 and Comparative Examples 1 to 5, a discharge capacity of about 2950 mAh was obtained because the charging voltage was as high as 4.35 V (4.45 V based on lithium in terms of the positive electrode potential).

This shows that improvement of the high-temperature cycling characteristics with maintaining a high charging capacity requires at least the following: the charging voltage of 4.25 to 4.5 V inclusive (4.35 to 4.6 V inclusive based on lithium in terms of the potential of the positive electrode), which is higher than 4.2 V of conventional examples; the low-viscosity solvent having a viscosity of 0.6 cP or less at 25° C. to be contained in the nonaqueous electrolyte in an amount of 35 to 80% by volume inclusive; and addition of HMDI. The results described above also show that the HDMI addition amount is preferably 0.5 to 4% by mass inclusive.

While the above-described examples exemplify the nonaqueous electrolyte secondary battery that includes the lithium cobalt oxide containing erbium as a dissimilar element as the positive electrode active material, the present invention can include any positive electrode active material that is commonly used as long as the material can stably exist under the potential of the positive electrode of 4.35 to 4.6 V inclusive based on lithium and can absorb and desorb lithium ions in a reversible manner. In particular, the dissimilar metal-added lithium-cobalt composite oxide is preferable that contains at least one selected from Zr, Mg, Al, and lanthanoid elements as dissimilar metals. Erbium (Er) is preferable as a lanthanoid element.

While the inorganic particles to be contained in the surface layers of the separator are exemplified by the material including silicon dioxide, any material can be used as long as it has an insulating property and is unlikely to react with the nonaqueous electrolyte. Oxides and nitrides of silicon, aluminum, and titanium can also be used as the inorganic particles to be contained. Silicon dioxide and aluminum oxide are preferable in particular.

While the above-described examples exemplify the cylindrical nonaqueous electrolyte secondary battery that includes the wound electrode assembly, the present invention does not depend on the shape of the electrode assembly of the nonaqueous electrolyte secondary battery. Therefore, the present invention is also applicable to a rectangular or elliptical nonaqueous electrolyte secondary battery that includes a flat wound electrode assembly and to a stacked nonaqueous electrolyte secondary battery in which a positive electrode plate and a negative electrode plate are stacked on each other with a separator interposed therebetween.

1. A nonaqueous electrolyte secondary battery system comprising:
a nonaqueous electrolyte secondary battery including a positive electrode plate containing a positive electrode active material that is capable of absorbing and desorbing lithium in a reversible manner, a negative electrode plate containing a negative electrode active material that is capable of absorbing and desorbing lithium in a reversible manner, a separator, and a nonaqueous electrolyte in which an electrolyte salt is dissolved in a nonaqueous solvent; and
a charging control system detecting a voltage of the nonaqueous electrolyte secondary battery and disconnecting a charging circuit,
the nonaqueous electrolyte containing a nonaqueous solvent having a viscosity of 0.6 cP or less at 25° C. in an amount of 35 to 80% by volume inclusive as the nonaqueous solvent and also containing hexamethylene diisocyanate, and
the charging control system stopping charging when the potential of the positive electrode of the nonaqueous electrolyte secondary battery is 4.35 to 4.6 V inclusive based on lithium.

2. The nonaqueous electrolyte secondary battery system according to claim 1, wherein the nonaqueous electrolyte contains hexamethylene diisocyanate in an amount of 0.5 to 4.0% by mass inclusive.

3. The nonaqueous electrolyte secondary battery system according to claim 1, wherein the negative electrode active material is a carbonaceous material.

4. The nonaqueous electrolyte secondary battery system according to claim 2, wherein the negative electrode active material is a carbonaceous material.

5. The nonaqueous electrolyte secondary battery system according to claim 1, wherein the nonaqueous solvent having a viscosity of 0.6 cP or less at 25° C. is at least one selected from dimethyl carbonate, methyl acetate, methyl ethyl ketone, ethyl acetate, methyl propionate, and n-propyl acetate.
